(19) United States
(12) Patent Application Publication
(10) Pub. No.: US 2011/0214698 A1
(43) Pub. Date: Sep. 8, 2011

(54) PARTS WASHER

(75) Inventors: Dustin Hrubetz, Lake Mills, IA (US); Eric Willey, Albert Lea, MN (US)

(73) Assignee: Fountain Industries, Albert Lea, MN (US)

(21) Appl. No.: 12/853,043

(22) Filed: Aug. 9, 2010

Related U.S. Application Data
(63) Continuation-in-part of application No. 12/716,867, filed on Mar. 3, 2010, now abandoned.

(51) Int. Cl. B08B 3/00

(52) U.S. Cl. 134/32; 134/137

(57) ABSTRACT

The present disclosure provides a cleaning machine that submerges devices to be cleaned in a cleaning fluid and moves the devices in a reciprocating motion to provide cleaning agitation. In one embodiment, the reciprocating motion is driven by the inflation and deflation of an air bladder. Related methods of manufacturing and cleaning are also provided.

### RELATED APPLICATION

This application is a continuation-in-part of U.S. patent application Ser. No. 12/716,867 filed on Mar. 3, 2010 titled PARTS WASHER, which is hereby incorporated by reference in its entirety.

### TECHNICAL FIELD

The present disclosure relates to a machine for cleaning parts and related methods.

### BACKGROUND

Machines configured to clean parts commonly known as parts washers can be configured to partially or entirely submerge parts to be cleaned in a cleaning fluid. Some of these types of machines are further configured to agitate the part to be cleaned as they are submerged in the cleaning fluid. For example, U.S. Pat. No. 5,186,193 discloses a machine that includes a tray for holding parts to be cleaned that is configured to be raised and lowered within a solution tank via extension and retraction of a vertically arranged pneumatic cylinder. Improved parts washing machines and methods are desirable.

### SUMMARY

The present disclosure provides a cleaning machine that submerges devices to be cleaned in a cleaning fluid, and moves the devices in a reciprocating motion to provide cleaning agitation. In one embodiment, the reciprocating motion is driven by the inflation and deflation of an air bladder. Related methods of manufacturing and cleaning are also provided.

### BRIEF DESCRIPTION OF THE FIGURES

FIG. 1 is a front perspective view of a cleaning machine according to principles of the present disclosure;

FIG. 2 is a front perspective view of the cleaning machine of FIG. 1 with exterior portions shown in hidden lines exposing internal portions with a parts holding device in a fully raised position;

FIG. 3 is a front perspective view of the cleaning machine of FIG. 1 with exterior portions shown in hidden lines exposing internal portions with a parts holding device in a fully lowered position;

FIG. 4 is a bottom perspective view of the cleaning machine of FIG. 1;

FIG. 5 is a diagram illustrating an air circuit of the cleaning machine of FIG. 1;

FIG. 6 is a front perspective view of an alternative embodiment of the cleaning machine of FIG. 1;

FIG. 7 is a front perspective view of the cleaning machine of FIG. 6 with exterior portions shown in hidden lines exposing internal portions with a parts holding device in a fully lowered position; and

FIG. 8 is a front perspective view of the cleaning machine of FIG. 6 with exterior portions shown in hidden lines exposing internal portions with a parts holding device in an intermediate position.

### DETAILED DESCRIPTION

The present disclosure provides a cleaning machine, also referred to herein as a parts washer. It should be appreciated that the cleaning machine can be used to clean any type of devices whether or not the device is a part (e.g., remove grease and grime from automobile parts, remove grease and grime from tools, etc.). The cleaning machine of the present disclosure is of the type that is configured to submerge parts to be cleaned in a fluid used to clean the devices (also referred to herein as cleaning fluid, solvent, cleaning solution). In the depicted embodiment the cleaning machine is configured to move the parts while they are submerged in the cleaning fluid to facilitate the cleaning process.

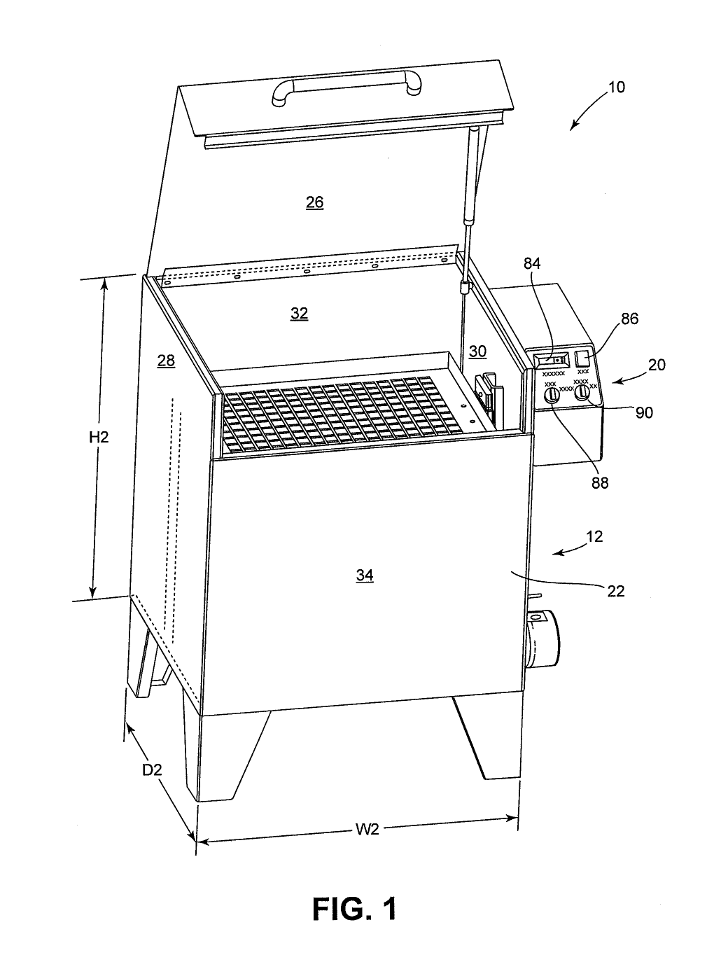

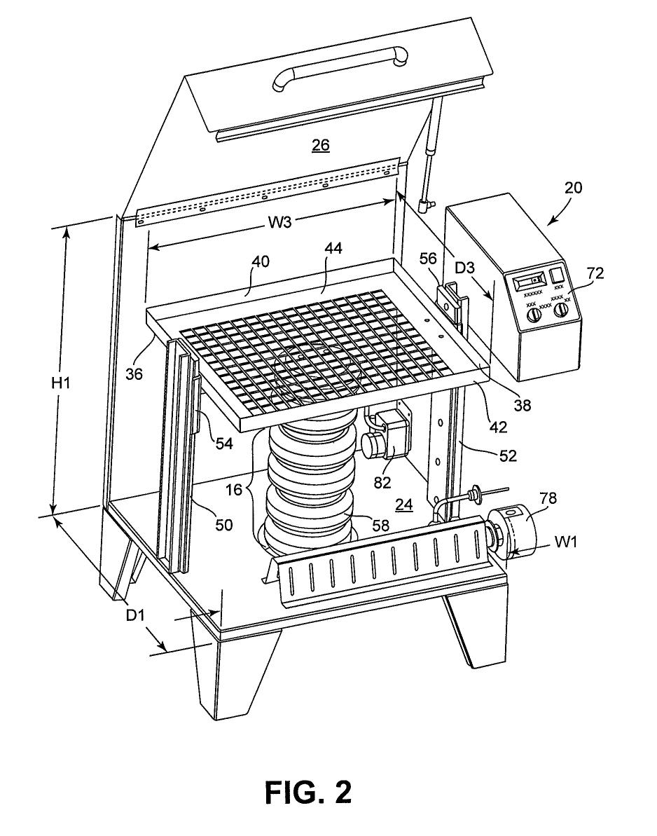

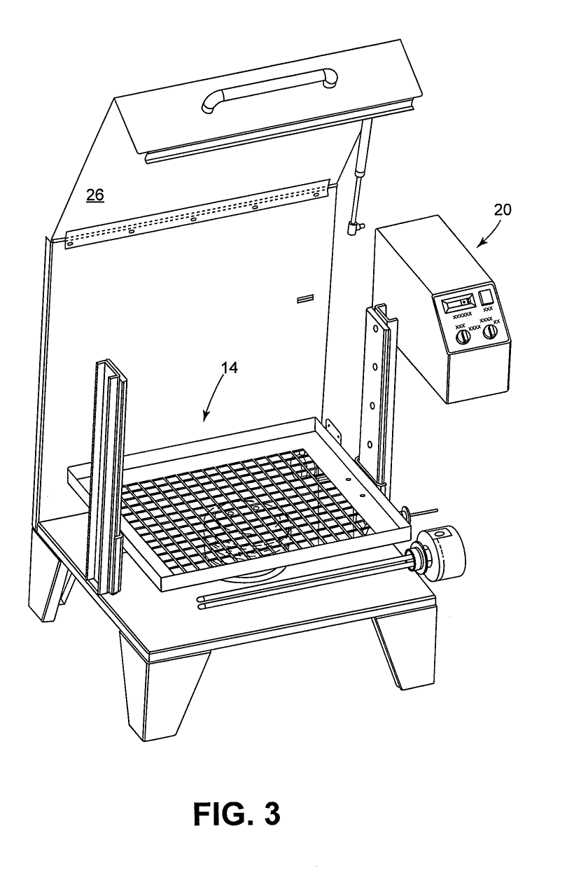

Referring to FIGS. 1-3, an embodiment of the present disclosure is described in greater detail. In the depicted embodiment, the parts washer 10 includes a fluid reservoir 12, a parts holder 14 configured to submerge parts into the fluid reservoir 12, an agitation assembly 16 for moving the parts holder 14, and a control unit 20.

In the depicted embodiment the fluid reservoir 12 is configured to define the outer shape of the parts washer 10. In particular, the fluid reservoir 12 is box shaped with a height H1 (e.g., 29.0 inches), width W1 (e.g., 26.4 inches), and depth D1 (23.1 inches). The outer shape of the parts washer 10 is also boxed shaped having a height H2 (e.g., 38.2 inches), a width W2 (28.0 inches), and depth D2 (25.1 inches). The depicted arrangement is compact in that the space that the parts washer 10 takes up is relatively close to the volume of the fluid reservoir 12. In the depicted embodiment, the space the parts washer takes up (H2×W2×D2) is less than forty-five percent greater than the volume of the fluid reservoir (H1×W1×D1). In the depicted embodiment the total volume of the parts washer is thirty four percent greater than the volume of the reservoir. In addition, the floor space that is occupied by the parts washer (W2×D2) is less than twenty percent greater than the cross-sectional area of the fluid reservoir (W1×D2). In the depicted embodiment the floor space occupied by the parts washer is thirteen percent greater than the cross-sectional area of the fluid reservoir.

In the depicted embodiment the fluid reservoir 12 includes a side wall 22, a bottom wall 24, and a cover 26. The side wall 22 includes four rectangular sections (first section 28, second section 30, third section 32, and fourth section 34) that are adjacent the outside surfaces of the parts washer 10. In the depicted embodiment the sides of fluid reservoir 12 also define the outer surface of the parts washer 10. It should be appreciated that in alternative embodiments the outer surface of the parts washer 10 can be separate from the fluid reservoir (e.g., the outer surface could be steel panels bolted to a frame and the reservoir can be a polymer tank supported on the frame).

In the depicted embodiment the parts holder 14 is configured to support parts to be clean as they are cleaned in the parts washer 10. In particular, the parts holder 14 secures the parts as they are submerged in the fluid reservoir 12. In the depicted embodiment the parts holder is a rectangular tray with side walls 36, 38, 40, 42 and a bottom wall 44 with openings. In the depicted embodiment the bottom wall has a width W3 (e.g., 24.0 inches) and a depth D3 (e.g., 20.0 inches). The area of the bottom wall 44 (W3×D3) is less than thirty percent greater than the cross-sectional area of the fluid reservoir (W1×D2) (e.g, the area of the bottom is twenty one percent greater than the area of cross-sectional area of the fluid reservoir). In the depicted embodiment the bottom wall 44 is a mesh lattice defining a surface with significantly more open spaces than closed spaces. It should be appreciated that many other part holder configurations are possible. For example, alternative parts holders can be mesh nets, boxes with perforations, trays with apertures punched therein, etc.

In the depicted embodiment the agitation assembly 16 includes a slide assembly and a lift assembly that are housed within the parts washer. In the depicted embodiment the slide assembly is configured to enable the parts holder 14 to slide in a vertical direction within the fluid reservoir 12. The slide assembly includes a first rail 50 connected to the first section 28 of the side wall 22 of the fluid reservoir 12, a second rail 52 connected to a second section 30 of the side wall 22 of the reservoir 12. Slide blocks 54, 56 (also referred to herein as slide members) are connected to side walls 36, 38 of the parts holder 14 and are configured to slide on the rails 50, 52.

In the depicted embodiment the lift assembly of the agitation assembly 16 includes an inflatable bladder 58 that is positioned between the parts holder 14 and the bottom wall 24 of the fluid reservoir 12. The lift assembly 48 is configured to move the parts holder 14 into a number of positions including: a first agitation orientation; a second agitation orientation; and loading orientation. The loading orientation is the uppermost orientation that corresponds to an orientation where the parts holder 14 is raised above the fluid (e.g., the loading orientation can be at least twenty-five inches from the bottom wall 24). The first agitation orientation is located at an upper end of the fluid reservoir 12 below a loading orientation wherein the tray is submerged (e.g., the first agitation orientation can be at least twenty inches from the bottom wall 24). The second agitation orientation is located adjacent the bottom wall 24 of the fluid reservoir 12 (e.g., the second agitation orientation can be at less than ten inches from the bottom wall 24 or, more preferably, less than six inches from the bottom wall 24). In the depicted embodiment, the distance between the first agitation orientation and the second agitation orientation (e.g., ten inches) is relatively close to the overall height H2 of the parts washer and even closer to the height H1 of the fluid reservoir 12. In the depicted embodiment both agitation orientations correspond to submerged orientation, but it should be appreciated that many other alternative configurations are also possible (e.g., the first agitation orientation and loading orientation can be at the same position either submerged or not submerged).

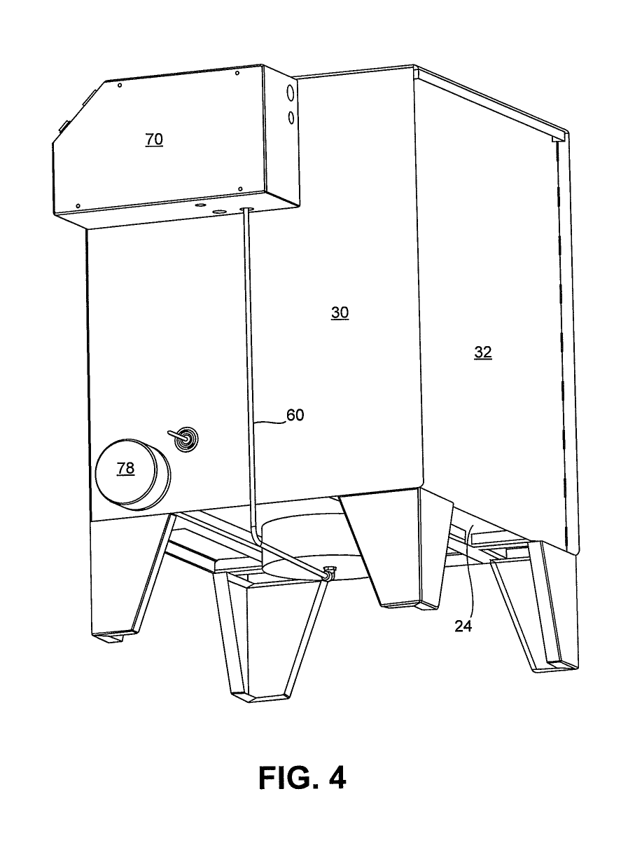

In the depicted embodiment the lift assembly is configured so that inflating the bladder 58 raises the parts holder 14, and deflating the bladder 58 lowers the parts holder 14. In the depicted embodiment a fluid is delivered to and removed from the bladder 58, via fluid line 60 (see FIG. 4). It should be appreciated that the fluid can be any fluid including gases fluid (e.g., air) or liquid fluid (water, solvent, etc.). In the depicted embodiment the fluid is air supplied from an air compressor (not shown).

In the depicted embodiment the lift assembly is configured such that it can be set to automatically and continuously reciprocate between the first agitation orientation and the second agitation orientation. The lift assembly includes a position switch 62, which when activated is configured to trigger the automatic deflation of the bladder 58 which causes the lowering of the tray 14. In the depicted embodiment, the position switch 62 is positioned at a first agitation orientation. When the lift assembly is set to agitate, the bladder 58 is inflated until the position switch 62 is triggered upon reaching the first agitation orientation. The bladder is then deflated until the parts holder 14 reaches the second agitation orientation upon which bladder 58 is then re-inflated until the parts holder 14 is raised again to the first agitation orientation. This reciprocation motion of the parts holder 14 between the first and second agitation orientation facilitates the cleaning.

In the depicted embodiment the control unit 20 includes a housing 70 and a user interface 72. In the depicted embodiment the housing 70 houses the control components including the valve configuration 74 that drives the lift assembly 48, a heater control connected to a heater 78, and a pump control connected to a pump 82. In the depicted embodiment the valve configuration is non-electrical. It is mechanical in nature in that it is powered by the fluid pressure and can operate without electrical energy. In the depicted embodiment, the heater 78 is used to heat the cleaning fluid to facilitate cleaning, and the pump 82 is used to circulate the cleaning fluid to facilitate cleaning. The user interface 72 includes user controls and displays including a temperature read out 84 a heater on/off toggle 86, a pump on/off dial 88, and a lift assembly dial 90. The lift assembly dial can be configured to manually raise the parts holder 14, manually lower the parts holder 14, or agitate the parts holder 14.

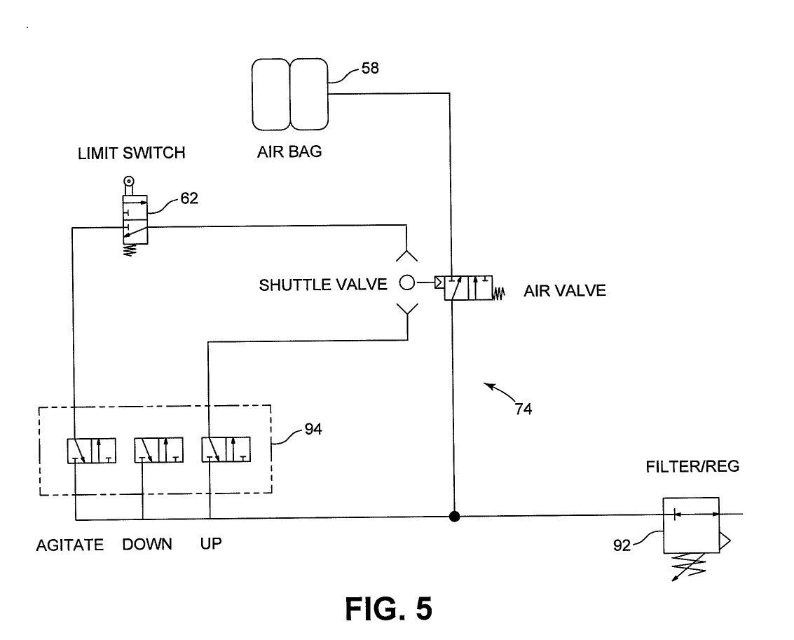

Referring to FIG. 5, the fluid circuit of the lift assembly is shown. The fluid exits a filter/regulator 92 and enters a first valve component 94 that is either in an orientation that results in agitation, manual raise, or manual lowering. The orientation of the first valve component 94 is set by lift assembly dial 90. Depending on the orientation of the first valve component 94, the position switch 62 is either activated or bypassed. When the lift assembly dial 90 is set to agitate, the limit switch 62 is activated, resulting in reciprocating motion of the parts holder in the vertical direction between the first and second agitation orientations.

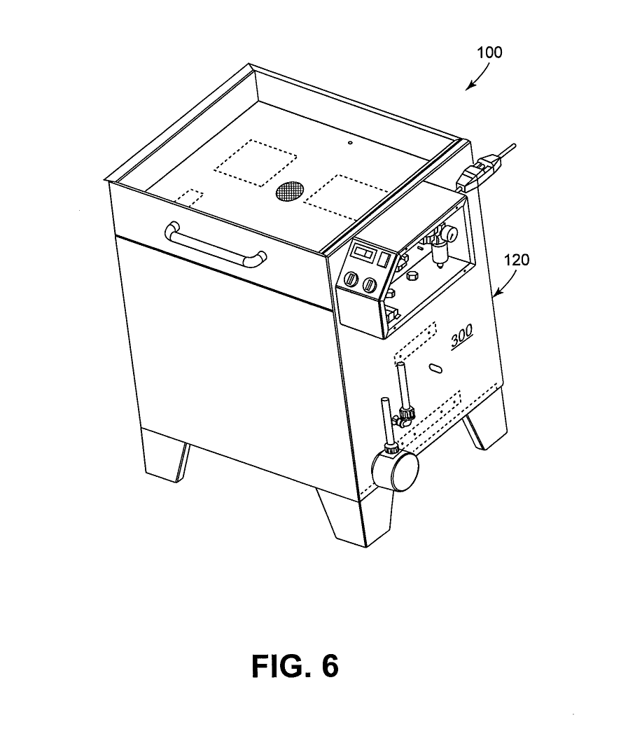

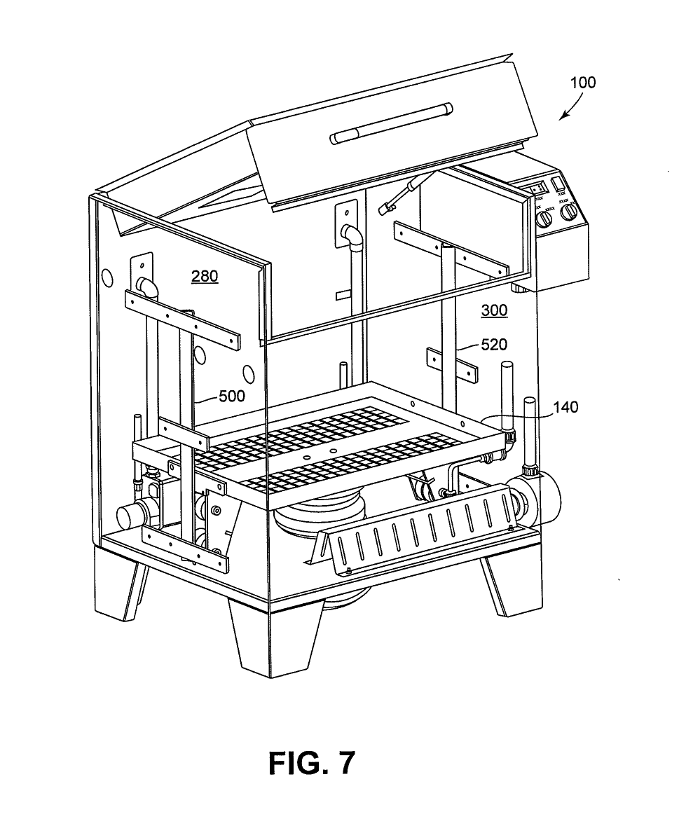

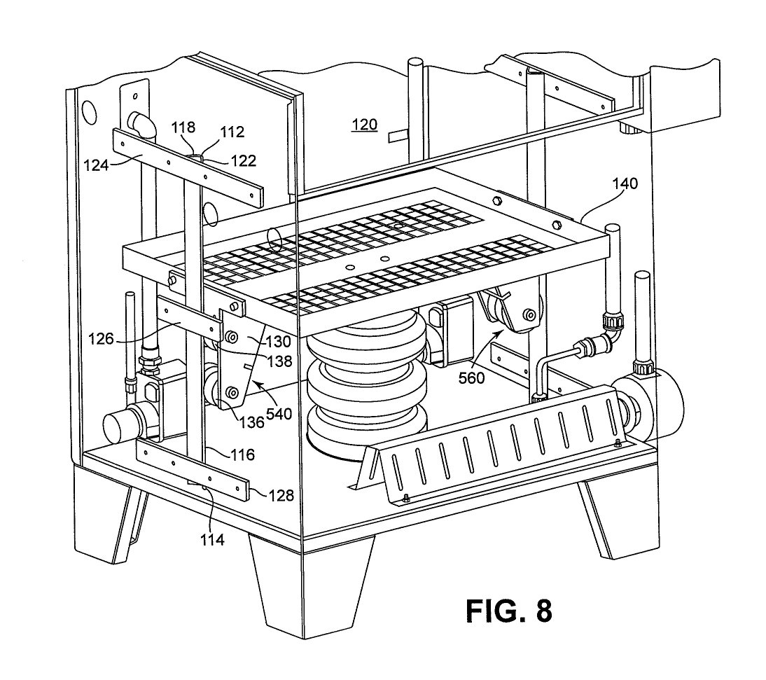

Referring to FIGS. 6-8, an alternative embodiment of the parts washer 10 is shown. Many of the features depicted are similar or identical to features of the parts washer 10 described above. The parts washer 100 of the alternative embodiment has a different slide assembly configuration than the parts washer 10.

In the depicted embodiment the slide assembly is configured to enable the parts holder 140 to slide in a vertical direction within the fluid reservoir 120. The slide assembly includes a first rail 500 connected to the first section 280 of the side wall of the fluid reservoir 120, a second rail 520 connected to a second section 300 of the side wall of the reservoir 120. Roller block assemblies 540, 560 (also referred to herein as slide members) are connected to the parts holder 140 and are configured to slide on the rails 500, 520. The rails and roller block assemblies on each side are identical; therefore, only the left set will be described in greater detail below.

In the depicted embodiment the first rail 500 includes upper ends 112 and lower ends 114 and an elongated body 116 extending therebetween. The elongated body 116 of the rail 500 includes two slide surfaces 118, 122 that are at ninety degrees relative to each other. In the depicted embodiment, the upper end 112, lower end 114, and mid portion of the rail 500 are welded to cross braces 124, 126, 128. In the depicted embodiment, the cross braces and rail arrangement minimize deflection and vibrations that could cause binding. The angled slide surfaces are configured to engage rollers 136, 138 of the roller block assembly 540.

In the depicted embodiment the roller block assembly 540 includes a frame 130 that is configured to mount to the side of the parts holder 140. The frame 130 supports an upper roller (wheel) 138 and a lower roller 136 that guide the parts holder 140 up and down on the rail 500. In the depicted embodiment, the wheels are constructed of a polymeric material. In the depicted embodiment, the wheels have a harness of between about 70 to 100 durometer (A scale). It should be appreciated than many other roller block configurations are also possible.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A parts washer comprising:
a fluid reservoir configured to house a cleaning fluid;
a parts holder configured to move in at least a vertical direction within the reservoir from a raised orientation to a lowered orientation;
an actuating assembly configured to raise and lower the parts holder, wherein the actuating assembly includes a gas actuated lift member located in the reservoir under the parts holder.

2. The parts washer of claim 1, wherein the gas actuated lift member is an inflatable bladder.

3. The parts washer of claim 1, wherein when the parts holder is in the lower orientation, the tray can be within ten inches from the bottom surface of the fluid reservoir.

4. The parts washer of claim 3, wherein when the parts holder is in the raised orientation, the tray can be at least twenty inches from the bottom surface of the fluid reservoir.

5. The parts washer of claim 1, wherein when the parts holder is in the lower orientation, the tray can be within six inches from the bottom surface of the fluid reservoir.

6. The parts washer of claim 5, wherein when the parts holder is in the raised orientation, the tray can be at least twenty inches from the bottom surface of the fluid reservoir.

7. The parts washer of claim 1, further comprising a slide assembly mounted within the reservoir, wherein the slide assembly is configured to enable the parts holder to slide in a vertical direction within the fluid reservoir.

8. The parts washer of claim 7, wherein the slide assembly includes a first rail and a second rail, wherein the parts holder includes a parts tray, the parts tray including a first member connected to a first slide member that is configured to connect to and slide relative to the first rail, and a second member opposite the first member connected to a second slide member that is configured to connect to and slide relative to the second rail.

9. The parts washer of claim 1, wherein all of the moving parts of the parts washer are located within the fluid reservoir.

10. The parts washer of claim 1, wherein the actuating assembly is configured to continually raise and lower the parts holder automatically during washing operations.

11. The parts washer of claim 10, wherein raising and lowering the parts holder is solely powered by the gas pressure.

12. The parts washer of claim 1, further comprising a control console, the control console including: a manual switch that can be set for reciprocating agitation, wherein the reciprocating agitation setting is configured so that air is delivered to the gas actuated lift member until a position limit switch is activated, which triggers air flow out of the gas actuated lift member.

13. The parts washer of claim 12, wherein the manual switch can be set to lift the parts holder in a vertical direction past the position limit switch.

14. The parts washer of claim 12, wherein the manual switch can be set to lower the parts holder in a vertical direction.

15. A parts washer comprising:
an outer housing defining a foot print having a first area;
a fluid reservoir including a bottom wall having a second area, wherein the first area is less than twenty percent greater than the second area;
a tray configured to move in at least a vertical direction within the reservoir from a raised orientation to a lowered orientation;
an actuating assembly configured to raise and lower the tray, wherein the actuating assembly includes a gas actuated lift member located in the reservoir under the tray.

16. The parts washer of claim 15, wherein the gas actuated lift member is an inflatable air bladder.

17. The parts washer of claim 15, wherein when the tray is in the lower orientation, the tray can be within ten inches from the bottom wall of the fluid reservoir, and wherein when the tray is in the raised orientation, the tray can be at least twenty inches from the bottom surface of the reservoir.

18. The parts washer of claim 15, further comprising a slide assembly mounted within the reservoir, wherein the slide assembly is configured to enable the tray to slide in a vertical direction within the reservoir.

19. A method of washing parts, comprising:
raising a parts holder by inflating an air bladder that is at least partially submerged in a solvent reservoir.

20. The method of claim 19, raising and lowering the parts holder in a reciprocating motion by inflating the air bladder until the parts holder is raised to a set position and automatically deflating the air bladder to allow the parts holder to lower.
